(19) United States
(12) Patent Application Publication
(10) Pub. No.: US 2016/0140503 A1
(43) Pub. Date: May 19, 2016

(54) DATABASE SYSTEMS AND METHODS FOR USING CREDIBILITY RATINGS OF USERS TO PROCESS ONLINE RESUMES IN A SOCIAL NETWORKING ENVIRONMENT

(71) Applicant: salesforce.com, inc., San Francisco, CA (US)

(72) Inventor: Daniel Everett Jemiolo, Cary, NC (US)

(21) Appl. No.: 14/546,965

(22) Filed: Nov. 18, 2014

(51) Int. Cl. G06Q 10/10; G06F 17/30; G06Q 50/00

(52) U.S. Cl. CPC G06Q 10/1053; G06Q 50/01; G06F 17/3053; G06F 17/30876

(57) ABSTRACT

Disclosed are examples of systems, apparatus, methods, and computer program products for determining the credibility of resumes or resume components posted to an online social network. For example, a rating user may rate the credibility of a resume component posted by a posting user to an online social network. The rating given by the rating user may be adjusted according to a credibility indicator associated with the rating user. The adjusted credibility rating may be used, possibly in combination with adjusted credibility ratings from other rating users, to calculate a weighted average credibility rating for the resume component that will then be visible to users of the online social network. The weighted average credibility rating may be an indication of the credibility of a resume or resume component.

### COPYRIGHT NOTICE

A portion of the disclosure of this patent document contains material which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever.

### TECHNICAL FIELD

This patent document generally relates to determining the reliability of online resumes maintained in a database system. More specifically, this patent document discloses techniques for rating resumes posted online on social networking systems implemented using database systems based on feedback from users of a social networking system.

### BACKGROUND

Databases may be maintained to store online resumes posted by users of a social networking website. For example, online resumes may have a “work experience” section listing a history of multiple jobs held by a user. A user who posts his resume to the social networking site may have drafted a characterization of each job in the list with information such as length of time worked, titles held, job descriptions, projects worked on, skills developed, and so forth.

### BRIEF DESCRIPTION OF THE DRAWINGS

The included drawings are for illustrative purposes and serve only to provide examples of possible structures and operations for the disclosed inventive systems, apparatus, methods and computer program products. These drawings in no way limit any changes in form and detail that may be made by one skilled in the art without departing from the spirit and scope of the disclosed implementations.

FIG. 1A shows a block diagram of an example of an environment 10 in which an on-demand database service can be used in accordance with some implementations.

FIG. 1B shows a block diagram of an example of some implementations of elements of FIG. 1A and various possible interconnections between these elements.

FIG. 2A shows a system diagram of an example of architectural components of an on-demand database service environment 200, in accordance with some implementations.

FIG. 2B shows a system diagram further illustrating an example of architectural components of an on-demand database service environment, in accordance with some implementations.

FIG. 3 shows a diagram illustrating an example of where data is stored and/or generated among a user device, one or more servers, and a database, in accordance with some implementations.

FIG. 4 shows a diagram illustrating an example of operations performed between a user device and a database system for using credibility ratings of users to process online resumes in a social networking environment, performed in accordance with some implementations.

FIG. 5 shows a diagram illustrating an example of operations performed between a user device and a database system for using credibility ratings of users to process online resumes in a social networking environment, performed in accordance with some implementations.

FIG. 6 shows a diagram illustrating an example of operations performed among a user device, one or more servers, and a database for using credibility ratings of users to process online resumes in a social networking environment, performed in accordance with some implementations.

FIG. 7 shows an example of a presentation of an online resume in the form of a graphical user interface (GUI) as displayed on a computing device, in accordance with some implementations.

FIG. 8 shows an example of a presentation of another online resume in the form of a GUI as displayed on a computing device, in accordance with some implementations.

### DETAILED DESCRIPTION

Examples of systems, apparatus, methods and computer program products according to the disclosed implementations are described in this section. These examples are being provided solely to add context and aid in the understanding of the disclosed implementations. It will thus be apparent to one skilled in the art that implementations may be practiced without some or all of these specific details. In other instances, certain operations have not been described in detail to avoid unnecessarily obscuring implementations. Other applications are possible, such that the following examples should not be taken as definitive or limiting either in scope or setting.

In the following detailed description, references are made to the accompanying drawings, which form a part of the description and in which are shown, by way of illustration, specific implementations. Although these implementations are described in sufficient detail to enable one skilled in the art to practice the disclosed implementations, it is understood that these examples are not limiting, such that other implementations may be used and changes may be made without departing from their spirit and scope. For example, the operations of methods shown and described herein are not necessarily performed in the order indicated. It should also be understood that the methods may include more or fewer operations than are indicated. In some implementations, operations described herein as separate operations may be combined. Conversely, what may be described herein as a single operation may be implemented in multiple operations.

Some implementations of the disclosed systems, apparatus, methods and computer program products are configured to use ratings to assess the credibility of online resumes or resume components posted by a user on a social networking system such as LinkedIn®. The online resume can be stored in a database system in the form of one or more data objects such as items in a database table, documents and/or files containing content of the resume. A “resume component” or “component of a resume” as used herein generally refers to one or a combination of sections or parts of content of a resume such as a description of a job, a job title, a term of employment, a project worked on, a contribution, an endorsement, a skill, a badge, an award won, or a hyperlink to a website or web page dedicated to an organization or group within an organization. Other various examples of resume components storing resume content are possible. In some implementations, pointers in a database system can link any number of data objects to define part or all of a resume and can incorporate content from various sources such as user profiles in a social networking system. In some implementations, a user profile serves as the resume.

As used herein, “posting user” generally refers to a user who has posted an online resume, profile, or work history information in a social networking system, while “rating user” generally refers to a user who has rated the credibility of the posting user's online resume, profile, or work history information or a component thereof. The users are generally members of the same social networking system, although in some implementations, users who are not members of the social networking system can be provided with limited permission to submit credibility ratings and/or post resumes. The ratings of multiple rating users may be combined in various manners to produce a consolidated or total credibility rating. In some implementations, weights can be applied to credibility ratings, for instance, based on who is the user submitting a rating, for determining a weighted average adjusted credibility rating to serve as a total credibility rating. The particular weights to be applied can be user-specified and/or can depend on one or a combination of factors.

In some implementations, one or more credibility indicators may be assigned to a rating user. The credibility indicator indicates the reliability of ratings submitted by the rating user. In some implementations, the credibility indicator may be automatically determined for the rating user based on one or a combination of factors such as the rating user's rating history, the credibility ratings of items posted by the rating user, the comments from or regarding the rating user, contacts of the rating user, the geographical location of the rating user, the rating user's areas of expertise, and the rating user's experience level. In some implementations, the credibility indicator may be used to determine or modify a weight used to determine a weighted average adjusted credibility rating. In some implementations, a single credibility indicator may be used to modify all of the rating user's ratings. In other implementations, any number of credibility indicators may be assigned to the rating user, and the particular credibility indicator to be used to adjust a credibility rating may vary depending on a variety of factors such as what aspect of an online resume is being rated, whether the online resume being rated belongs to a contact or a friend of the rating user, whether the rating user worked as a team member with the posting user, etc.

In some implementations, a social networking system allows users to “friend” or otherwise establish a connection with other users and post some or all of the resume content described above in a user profile maintained in a database of the social networking system. The social networking system may be provided on one or more websites hosted by servers of a database system. It should be appreciated that, in some implementations, techniques described herein are not limited to social networking systems in which the primary focus is professional contacts and/or recruitment and are applicable in the context of various other database systems and/or social networking systems such as Chatter®, Facebook®, Twitter®, Google+®, Yammer® and Jive®, by way of example only. In addition, the techniques described herein may be implemented on websites and platforms other than social networking systems.

By way of illustration, Steve has created and posted a user profile on a social networking system. While Steve's profile primarily concerns his everyday social life, as he mainly posts pictures of his family, his profile also includes a section listing his employment history. The employment history section includes information identifying his current employer and past employers, the titles he held at his various places of employment, and a short description of each role he held during employment. The employment history information is organized by the identity of the employer. That is, Steve's profile has a component for each employer.

In this example, the social networking system allows users to rate the credibility of other users' resumes maintained on the social networking system. For instance, a user can rate the credibility of each section or specific component of the posting user's employment history on a scale of 1 to 10, with 10 being the most credible and 1 being the least credible. Steve's profile lists three different employers: his current employer WaveTech, and his previous employers Jump, Inc. and Lanesra Beauty Products. Steve entered his WaveTech title as senior manager, his Jump, Inc. title as sales manager, and his Lanesra title as salesperson.

Credibility ratings are determined for each component of Steve's resume based on feedback from other users, using some of the disclosed techniques. In this example, Steve's description of his employment at WaveTech has a credibility rating of 9.0, which suggests that the description posted is very accurate. By contrast, the credibility rating calculated for Steve's description of his employment at Jump, Inc. is 5.5, suggesting that his entry for Jump, Inc. is much less credible than his entry for WaveTech. The lower rating for Jump, Inc. may be due to the fact that Steve was only sales manager at Jump, Inc. for half of his term of employment with Jump, Inc. In fact, Steve had started as a salesperson at Jump, Inc., but his profile does not list his salesperson role. Finally, the calculated credibility rating for Steve's entry for Lanesra is 7.5, suggesting that the Lanesra entry is relatively accurate.

The various services and techniques described herein may be provided in a cloud computing environment, for example, in the context of a multitenant database system. In some implementations, the database may be structured to store and identify records, for example, in a hierarchical database model with certain records having child-parent or parent-child relationships with other records at different layers or positions in the hierarchy. Other implementations of the various services and techniques described herein may utilize an unstructured database model or system. Some of the described techniques and processes may be implemented without locally installed software on a user device, though other implementations may include locally installed software. While the disclosed implementations may be described with reference to cloud-based multitenant systems, it should be appreciated that the disclosed techniques and processes may be implemented in the context of various other database systems such as non-cloud-based systems or cloud-based systems that are not part of a multitenant database system.

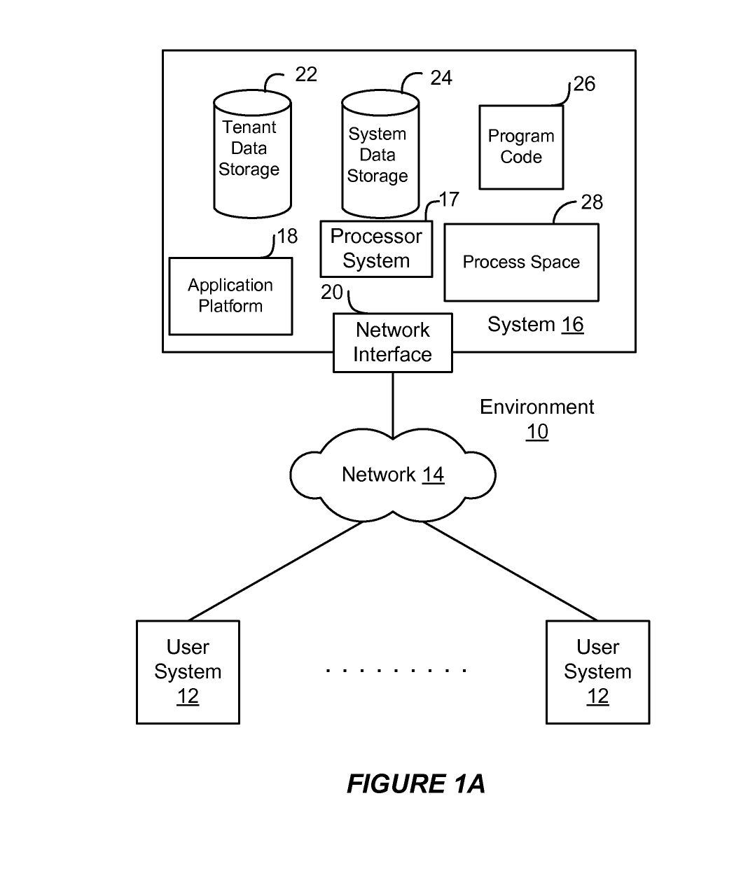

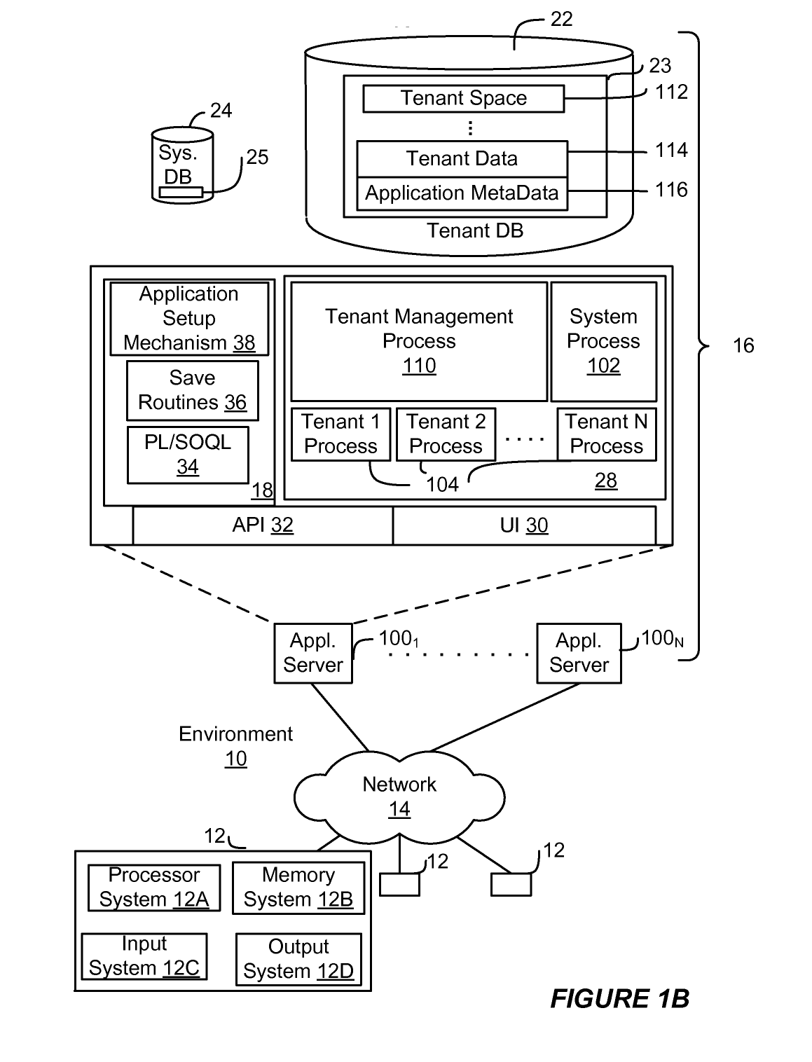

FIG. 1A shows a block diagram of an example of an environment 10 in which an on-demand database service can be used in accordance with some implementations. The environment 10 includes user systems 12, a network 14, a database system 16 (also referred to herein as a “cloud-based system”), a processor system 17, an application platform 18, a network interface 20, tenant database 22 for storing tenant database 23, system database 24 for storing system data 25, program code 26 for implementing various functions of the system 16, and process space 28 for executing database system processes and tenant-specific processes, such as running applications as part of an application hosting service. In some other implementations, environment 10 may not have all of these components or systems, or may have other components or systems instead of, or in addition to, those listed above.

In some implementations, the environment 10 is an environment in which an on-demand database service exists. An on-demand database service, such as that which can be implemented using the system 16, is a service that is made available to users outside of the enterprise(s) that own, maintain or provide access to the system 16. As described above, such users generally do not need to be concerned with building or maintaining the system 16. Instead, resources provided by the system 16 may be available for such users' use when the users need services provided by the system 16; that is, on the demand of the users. Some on-demand database services can store information from one or more tenants into tables of a common database image to form a multitenant database system (MTS). The term “multitenant database system” can refer to those systems in which various elements of hardware and software of a database system may be shared by one or more customers or tenants. For example, a given application server may simultaneously process requests for a great number of customers, and a given database table may store rows of data such as work items for a potentially much greater number of customers. A database image can include one or more database objects. A relational database management system (RDBMS) or the equivalent can execute storage and retrieval of information against the database object(s).

Application platform 18 can be a framework that allows the applications of system 16 to execute, such as the hardware or software infrastructure of the system 16. In some implementations, the application platform 18 enables the creation, management and execution of one or more applications developed by the provider of the on-demand database service, users accessing the on-demand database service via user systems 12, or third party application developers accessing the on-demand database service via user systems 12.

In some implementations, the system 16 implements a web-based customer relationship management (CRM) system. For example, in some such implementations, the system 16 includes application servers configured to implement and execute CRM software applications as well as provide related data, code, forms, renderable web pages and documents and other information to and from user systems 12 and to store to, and retrieve from, a database system related data, objects, and Web page content. In some MTS implementations, data for multiple tenants may be stored in the same physical database object in tenant database 22. In some such implementations, tenant data is arranged in the storage medium(s) of tenant database 22 so that data of one tenant is kept logically separate from that of other tenants so that one tenant does not have access to another tenant's data, unless such data is expressly shared. The system 16 also implements applications other than, or in addition to, a CRM application. For example, the system 16 can provide tenant access to multiple hosted (standard and custom) applications, including a CRM application. User (or third party developer) applications, which may or may not include CRM, may be supported by the application platform 18. The application platform 18 manages the creation and storage of the applications into one or more database objects and the execution of the applications in one or more virtual machines in the process space of the system 16.

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (for example, in a server farm located in a single building or campus), or they may be distributed at locations remote from one another (for example, one or more servers located in city A and one or more servers located in city B). As used herein, each MTS could include one or more logically or physically connected servers distributed locally or across one or more geographic locations. Additionally, the term “server” is meant to refer to a computing device or system, including processing hardware and process space(s), an associated storage medium such as a memory device or database, and, in some instances, a database application (for example, OODBMS or RDBMS) as is well known in the art. It should also be understood that “server system” and “server” are often used interchangeably herein. Similarly, the database objects described herein can be implemented as part of a single database, a distributed database, a collection of distributed databases, a database with redundant online or offline backups or other redundancies, etc., and can include a distributed database or storage network and associated processing intelligence.

The network 14 can be or include any network or combination of networks of systems or devices that communicate with one another. For example, the network 14 can be or include any one or any combination of a LAN (local area network), WAN (wide area network), telephone network, wireless network, cellular network, point-to-point network, star network, token ring network, hub network, or other appropriate configuration. The network 14 can include a TCP/IP (Transfer Control Protocol and Internet Protocol) network, such as the global internetwork of networks often referred to as the “Internet” (with a capital “I”). The Internet will be used in many of the examples herein. However, it should be understood that the networks that the disclosed implementations can use are not so limited, although TCP/IP is a frequently implemented protocol.

The user systems 12 can communicate with system 16 using TCP/IP and, at a higher network level, other common Internet protocols to communicate, such as HTTP, FTP, AFS, WAP, etc. In an example where HTTP is used, each user system 12 can include an HTTP client commonly referred to as a “web browser” or simply a “browser” for sending and receiving HTTP signals to and from an HTTP server of the system 16. Such an HTTP server can be implemented as the sole network interface 20 between the system 16 and the network 14, but other techniques can be used in addition to or instead of these techniques. In some implementations, the network interface 20 between the system 16 and the network 14 includes load sharing functionality, such as round-robin HTTP request distributors to balance loads and distribute incoming HTTP requests evenly over a number of servers. In MTS implementations, each of the servers can have access to the MTS data; however, other alternative configurations may be used instead.

The user systems 12 can be implemented as any computing device(s) or other data processing apparatus or systems usable by users to access the database system 16. For example, a given user system 12 can be a desktop computer, a work station, a laptop computer, a tablet computer, a handheld computing device, a mobile cellular phone (for example, a “smartphone”), or any other Wi-Fi-enabled device, wireless access protocol (WAP)-enabled device, or other computing device capable of interfacing directly or indirectly to the Internet or other network. The terms “user system” and “user device” are used interchangeably herein. As described above, each user system 12 typically executes an HTTP client, for example, a web browsing (or simply “browsing”) program, such as a web browser based on the WebKit platform, Microsoft's Internet Explorer browser, Netscape's Navigator browser, Opera's browser, Safari's browser, Mozilla's Firefox browser, Google's Chrome browser, or a WAP-enabled browser in the case of a cellular phone, PDA or other wireless device, or the like, allowing a user (for example, a subscriber of on-demand services provided by the system 16) of the user system 12 to access, process and view information, pages and applications available to it from the system 16 over the network 14.

Each user system 12 also typically includes one or more user input devices, such as a keyboard, a mouse, a trackball, a touch pad, a touch screen, a pen or stylus or the like, for interacting with a graphical user interface (GUI) provided by the browser on a display (for example, a monitor screen, liquid crystal display (LCD), light-emitting diode (LED) display, among other possibilities) of the user system 12 in conjunction with pages, forms, applications and other information provided by the system 16 or other systems or servers. For example, the user interface device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

The users of user systems 12 may differ in their respective capacities, and the capacity of a particular user system 12 can be entirely determined by permissions (permission levels) for the current user of such user system. For example, an implementation of the social networking system may have multiple tiers of users. The users may be tiered according to their account status, such as whether they are a paying account or whether the account is for an individual or a business, to their length of registration with the social networking system, their account properties, such as whether they are an ordinary user or an administrator, to their roles within a business, or to other properties associated with their accounts. The different tiers may have different associated permission levels. Where a hierarchical role model is used, users at one permission level can have access to applications, data, and database information accessible by a lower permission level user, but may not have access to certain applications, database information, and data accessible by a user at a higher permission level. Thus, different users generally will have different capabilities with regard to accessing and modifying application and database information, depending on the users' respective security or permission levels (also referred to as “authorizations”).

According to some implementations, each user system 12 and some or all of its components are operator-configurable using applications, such as a browser, including computer code executed using a central processing unit (CPU) such as an Intel Pentium®, Core®, or Xeon® processor or the like. Similarly, the system 16 (and additional instances of an MTS, where more than one is present) and all of its components can be operator-configurable using application(s) including computer code to run using the processor system 17, which may be implemented to include a CPU or multiple CPUs.

The system 16 includes tangible computer-readable media having non-transitory instructions stored thereon/in that are executable by or used to program a server or other computing system (or collection of such servers or computing systems) to perform some of the implementation of processes described herein. For example, computer program code 26 can implement instructions for operating and configuring the system 16 to intercommunicate and to process web pages, applications and other data and media content as described herein. In some implementations, the computer code 26 can be downloadable and stored on a hard disk, but the entire program code, or portions thereof, also can be stored in any other volatile or non-volatile memory medium or device as is well known, such as a ROM or RAM, or provided on any media capable of storing program code, such as any type of rotating media including floppy disks, optical discs, digital versatile disks (DVD), compact disks (CD), microdrives, and magneto-optical disks, and magnetic or optical cards, nanosystems (including molecular memory ICs), or any other type of computer-readable medium or device suitable for storing instructions or data. Additionally, the entire program code, or portions thereof, may be transmitted and downloaded from a software source over a transmission medium, for example, over the Internet, or from another server, as is well known, or transmitted over any other existing network connection as is well known (for example, extranet, VPN, LAN, etc.) using any communication medium and protocols (for example, TCP/IP, HTTP, HTTPS, Ethernet, etc.) as are well known. It will also be appreciated that computer code for the disclosed implementations can be realized in any programming language that can be executed on a server or other computing system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

FIG. 1B shows a block diagram of an example of some implementations of elements of FIG. 1A and various possible interconnections between these elements. That is, FIG. 1B also illustrates environment 10, but in FIG. 1B, various elements of the system 16 and various interconnections between such elements are shown with more specificity according to some more specific implementations. Additionally, in FIG. 1B, the user system 12 includes a processor system 12A, a memory system 12B, an input system 12C, and an output system 12D. The processor system 12A can include any suitable combination of one or more processors. The memory system 12B can include any suitable combination of one or more memory devices. The input system 12C can include any suitable combination of input devices, such as one or more touchscreen interfaces, keyboards, mice, trackballs, scanners, cameras, or interfaces to networks. The output system 12D can include any suitable combination of output devices, such as one or more display devices, printers, or interfaces to networks.

In FIG. 1B, the network interface 20 is implemented as a set of HTTP application servers 100₁-100_{N}. Each application server 100, also referred to herein as an “app server”, is configured to communicate with tenant database 22 and the tenant database 23 therein, as well as system database 24 and the system data 25 therein, to serve requests received from the user systems 12. The tenant database 23 can be divided into individual tenant storage spaces 112, which can be physically or logically arranged or divided. Within each tenant storage space 112, tenant data 114 and application metadata 116 can similarly be allocated for each user. For example, a copy of a user's most recently used (MRU) items can be stored to tenant data 114. Similarly, a copy of MRU items for an entire organization that is a tenant can be stored to tenant storage space 112.

The process space 28 includes system process space 102, individual tenant process spaces 104 and a tenant management process space 110. The application platform 18 includes an application setup mechanism 38 that supports application developers' creation and management of applications. Such applications and others can be saved as metadata into tenant database 22 by save routines 36 for execution by subscribers as one or more tenant process spaces 104 managed by tenant management process 110, for example. Invocations to such applications can be coded using PL/SOQL 34, which provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications can be detected by one or more system processes, which manage retrieving application metadata 116 for the subscriber making the invocation and executing the metadata as an application in a virtual machine.

The system 16 of FIG. 1B also includes a user interface (UI) 30 and an application programming interface (API) 32 to system 16 resident processes to users or developers at user systems 12. In some other implementations, the environment 10 may not have the same elements as those listed above or may have other elements instead of, or in addition to, those listed above.

Each application server 100 can be communicably coupled with tenant database 22 and system database 24, for example, having access to tenant database 23 and system data 25, respectively, via a different network connection. For example, one application server 100₁ can be coupled via the network 14 (for example, the Internet), another application server 100_{N-1} can be coupled via a direct network link, and another application server 100_{N} can be coupled by yet a different network connection. Transfer Control Protocol and Internet Protocol (TCP/IP) are examples of typical protocols that can be used for communicating between application servers 100 and the system 16. However, it will be apparent to one skilled in the art that other transport protocols can be used to optimize the system 16 depending on the network interconnections used.

In some implementations, each application server 100 is configured to handle requests for any user associated with any organization that is a tenant of the system 16. Because it can be desirable to be able to add and remove application servers 100 from the server pool at any time and for various reasons, in some implementations there is no server affinity for a user or organization to a specific application server 100. In some such implementations, an interface system implementing a load balancing function (for example, an F5 Big-IP load balancer) is communicably coupled between the application servers 100 and the user systems 12 to distribute requests to the application servers 100. In one implementation, the load balancer uses a least-connections algorithm to route user requests to the application servers 100. Other examples of load balancing algorithms, such as round robin and observed-response-time, also can be used. For example, in some instances, three consecutive requests from the same user could hit three different application servers 100, and three requests from different users could hit the same application server 100. In this manner, by way of example, system 16 can be a multitenant system in which system 16 handles storage of, and access to, different objects, data and applications across disparate users and organizations.

In one example storage use case, one tenant can be a company that employs a sales force where each salesperson uses system 16 to manage aspects of their sales. A user can maintain contact data, leads data, customer follow-up data, performance data, goals and progress data, etc., all applicable to that user's personal sales process (for example, in tenant database 22). In an example of a MTS arrangement, because all of the data and the applications to access, view, modify, report, transmit, calculate, etc., can be maintained and accessed by a user system 12 having little more than network access, the user can manage his or her sales efforts and cycles from any of many different user systems. For example, when a salesperson is visiting a customer and the customer has Internet access in their lobby, the salesperson can obtain critical updates regarding that customer while waiting for the customer to arrive in the lobby.

While each user's data can be stored separately from other users' data regardless of the employers of each user, some data can be organization-wide data shared or accessible by several users or all of the users for a given organization that is a tenant. Thus, there can be some data structures managed by system 16 that are allocated at the tenant level while other data structures can be managed at the user level. Because an MTS can support multiple tenants including possible competitors, the MTS can have security protocols that keep data, applications, and application use separate. Also, because many tenants may opt for access to an MTS rather than maintain their own system, redundancy, up-time, and backup are additional functions that can be implemented in the MTS. In addition to user-specific data and tenant-specific data, the system 16 also can maintain system level data usable by multiple tenants or other data. Such system level data can include industry reports, news, postings, and the like that are sharable among tenants.

In some implementations, the user systems 12 (which also can be client systems) communicate with the application servers 100 to request and update system-level and tenant-level data from the system 16. Such requests and updates can involve sending one or more queries to tenant database 22 or system database 24. The system 16 (for example, an application server 100 in the system 16) can automatically generate one or more SQL statements (for example, one or more SQL queries) designed to access the desired information. System database 24 can generate query plans to access the requested data from the database. The term “query plan” generally refers to one or more operations used to access information in a database system.

Each database can generally be viewed as a collection of objects, such as a set of logical tables, containing data fitted into predefined or customizable categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or element of a table can contain an instance of data for each category defined by the fields. For example, a database can include a table that describes a customer with fields for basic contact information such as name, address, phone number, fax number, etc. Another table can describe a purchase order, including fields for information such as customer, product, sale price, date, etc. Yet another table can describe a user's profile or resume information, such as employers, employment lengths, titles, and job descriptions. In some MTS implementations, standard entity tables can be provided for use by all tenants. For CRM database applications, such standard entities can include tables for case, account, contact, lead, and opportunity data objects, each containing pre-defined fields. As used herein, the term “entity” also may be used interchangeably with “object” and “table.”

In some MTS implementations, tenants are allowed to create and store custom objects, or may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multitenant database system. In some implementations, for example, all custom entity data rows are stored in a single multitenant physical table, which may contain multiple logical tables per organization. It is transparent to customers that their multiple “tables” are in fact stored in one large table or that their data may be stored in the same table as the data of other customers.

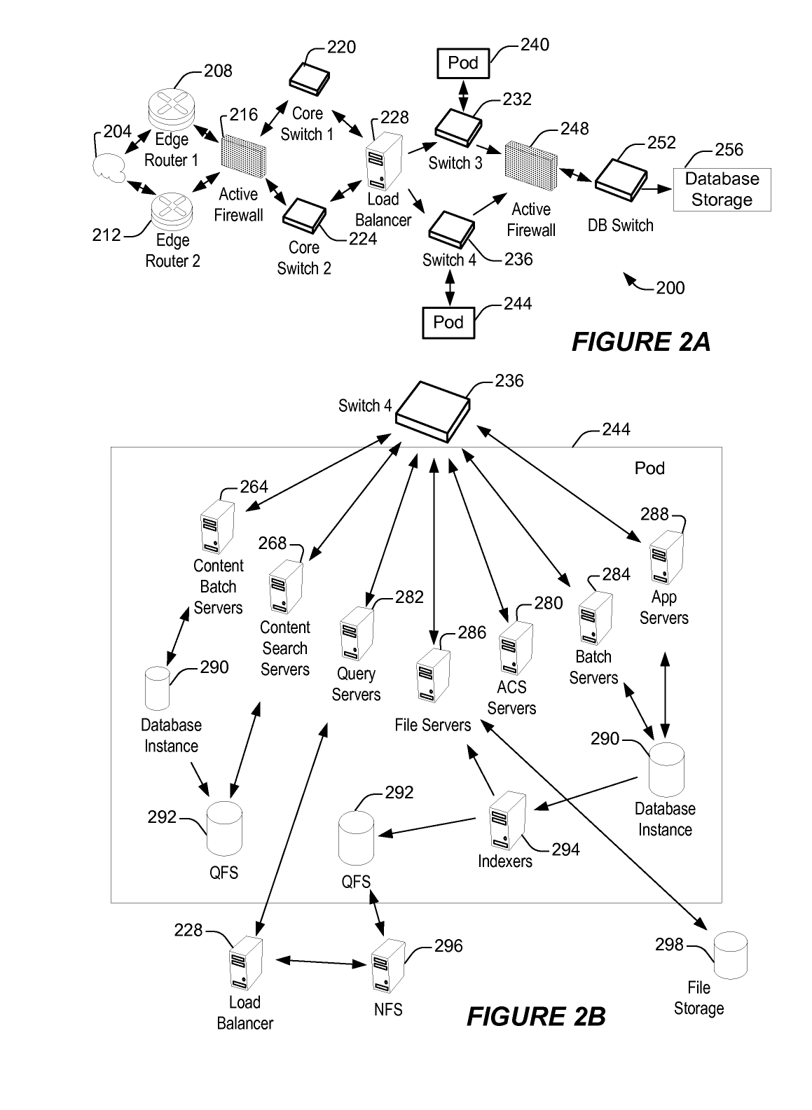

FIG. 2A shows a system diagram of an example of architectural components of an on-demand database service environment 200, in accordance with some implementations. A client machine communicably connected with the cloud 204, generally referring to one or more networks in combination, as described herein, can communicate with the on-demand database service environment 200 via one or more edge routers 208 and 212. A client machine can be any of the examples of user systems 12 described above. The edge routers can communicate with one or more core switches 220 and 224 through a firewall 216. The core switches can communicate with a load balancer 228, which can distribute server load over different pods, such as the pods 240 and 244. The pods 240 and 244, which can each include one or more servers or other computing resources, can perform data processing and other operations used to provide on-demand services. Communication with the pods can be conducted via pod switches 232 and 236. Components of the on-demand database service environment can communicate with database storage 256 through a database firewall 248 and a database switch 252.

As shown in FIGS. 2A and 2B, accessing an on-demand database service environment can involve communications transmitted among a variety of different hardware or software components. Further, the on-demand database service environment 200 is a simplified representation of an actual on-demand database service environment. For example, while only one or two devices of each type are shown in FIGS. 2A and 2B, some implementations of an on-demand database service environment can include anywhere from one to several devices of each type. Also, the on-demand database service environment need not include each device shown in FIGS. 2A and 2B, or can include additional devices not shown in FIGS. 2A and 2B.

Additionally, it should be appreciated that one or more of the devices in the on-demand database service environment 200 can be implemented on the same physical device or on different hardware. Some devices can be implemented using hardware or a combination of hardware and software. Thus, terms such as “data processing apparatus,” “machine,” “server” and “device” as used herein are not limited to a single hardware device, rather references to these terms can include any suitable combination of hardware and software configured to provide the described functionality.

The cloud 204 is intended to refer to a data network or multiple data networks, often including the Internet. Client machines communicably connected with the cloud 204 can communicate with other components of the on-demand database service environment 200 to access services provided by the on-demand database service environment. For example, client machines can access the on-demand database service environment to retrieve, store, edit, or process information. In some implementations, the edge routers 208 and 212 route packets between the cloud 204 and other components of the on-demand database service environment 200. For example, the edge routers 208 and 212 can employ the Border Gateway Protocol (BGP). The BGP is the core routing protocol of the Internet. The edge routers 208 and 212 can maintain a table of IP networks or ‘prefixes’, which designate network reachability among autonomous systems on the Internet.

In some implementations, the firewall 216 can protect the inner components of the on-demand database service environment 200 from Internet traffic. The firewall 216 can block, permit, or deny access to the inner components of the on-demand database service environment 200 based upon a set of rules and other criteria. The firewall 216 can act as one or more of a packet filter, an application gateway, a stateful filter, a proxy server, or any other type of firewall.

In some implementations, the core switches 220 and 224 are high-capacity switches that transfer packets within the on-demand database service environment 200. The core switches 220 and 224 can be configured as network bridges that quickly route data between different components within the on-demand database service environment. In some implementations, the use of two or more core switches 220 and 224 can provide redundancy or reduced latency.

In some implementations, the pods 240 and 244 perform the core data processing and service functions provided by the on-demand database service environment. Each pod can include various types of hardware or software computing resources. An example of the pod architecture is discussed in greater detail with reference to FIG. 2B. In some implementations, communication between the pods 240 and 244 is conducted via the pod switches 232 and 236. The pod switches 232 and 236 can facilitate communication between the pods 240 and 244 and client machines communicably connected with the cloud 204, for example via core switches 220 and 224. Also, the pod switches 232 and 236 may facilitate communication between the pods 240 and 244 and the database storage 256. In some implementations, the load balancer 228 can distribute workload between the pods 240 and 244. Balancing the on-demand service requests between the pods can assist in improving the use of resources, increasing throughput, reducing response times, or reducing overhead. The load balancer 228 may include multilayer switches to analyze and forward traffic.

In some implementations, access to the database storage 256 is guarded by a database firewall 248. The database firewall 248 can act as a computer application firewall operating at the database application layer of a protocol stack. The database firewall 248 can protect the database storage 256 from application attacks such as structure query language (SQL) injection, database rootkits, and unauthorized information disclosure. In some implementations, the database firewall 248 includes a host using one or more forms of reverse proxy services to proxy traffic before passing it to a gateway router. The database firewall 248 can inspect the contents of database traffic and block certain content or database requests. The database firewall 248 can work on the SQL application level atop the TCP/IP stack, managing applications' connection to the database or SQL management interfaces as well as intercepting and enforcing packets traveling to or from a database network or application interface.

In some implementations, communication with the database storage 256 is conducted via the database switch 252. The multitenant database storage 256 can include more than one hardware or software components for handling database queries. Accordingly, the database switch 252 can direct database queries transmitted by other components of the on-demand database service environment (for example, the pods 240 and 244) to the correct components within the database storage 256. In some implementations, the database storage 256 is an on-demand database system shared by many different organizations as described above with reference to FIGS. 1A and 1B.

FIG. 2B shows a system diagram further illustrating an example of architectural components of an on-demand database service environment, in accordance with some implementations. The pod 244 can be used to render services to a user of the on-demand database service environment 200. In some implementations, each pod includes a variety of servers or other systems. The pod 244 includes one or more content batch servers 264, content search servers 268, query servers 282, file servers 286, access control system (ACS) servers 280, batch servers 284, and app servers 288. The pod 244 also can include database instances 290, quick file systems (QFS) 292, and indexers 294. In some implementations, some or all communication between the servers in the pod 244 can be transmitted via the switch 236.

In some implementations, the app servers 288 include a hardware or software framework dedicated to the execution of procedures (for example, programs, routines, scripts) for supporting the construction of applications provided by the on-demand database service environment 200 via the pod 244. In some implementations, the hardware or software framework of an app server 288 is configured to execute operations of the services described herein, including performance of the blocks of various methods or processes described herein. In some alternative implementations, two or more app servers 288 can be included and cooperate to perform such methods, or one or more other servers described herein can be configured to perform the disclosed methods.

The content batch servers 264 can handle requests internal to the pod. Some such requests can be long-running or not tied to a particular customer. For example, the content batch servers 264 can handle requests related to log mining, cleanup work, and maintenance tasks. The content search servers 268 can provide query and indexer functions. For example, the functions provided by the content search servers 268 can allow users to search through content stored in the on-demand database service environment. The file servers 286 can manage requests for information stored in the file storage 298. The file storage 298 can store information such as documents, images, and basic large objects (BLOBs). By managing requests for information using the file servers 286, the image footprint in the database can be reduced. The query servers 282 can be used to retrieve information from one or more file systems. For example, the query system 282 can receive requests for information from the app servers 288 and transmit information queries to the NFS 296 located outside the pod.

The pod 244 can share a database instance 290 configured as a multitenant environment in which different organizations share access to the same database. Additionally, services rendered by the pod 244 may call upon various hardware or software resources. In some implementations, the ACS servers 280 control access to data, hardware resources, or software resources. In some implementations, the batch servers 284 process batch jobs, which are used to run tasks at specified times. For example, the batch servers 284 can transmit instructions to other servers, such as the app servers 288, to trigger the batch jobs.

In some implementations, the QFS 292 is an open source file system. The QFS can serve as a rapid-access file system for storing and accessing information available within the pod 244. The QFS 292 can support some volume management capabilities, allowing many disks to be grouped together into a file system. File system metadata can be kept on a separate set of disks, which can be useful for streaming applications where long disk seeks cannot be tolerated. Thus, the QFS system can communicate with one or more content search servers 268 or indexers 294 to identify, retrieve, move, or update data stored in the network file systems 296 or other storage systems.

In some implementations, one or more query servers 282 communicate with the NFS 296 to retrieve or update information stored outside of the pod 244. The NFS 296 can allow servers located in the pod 244 to access information to access files over a network in a manner similar to how local storage is accessed. In some implementations, queries from the query servers 282 are transmitted to the NFS 296 via the load balancer 228, which can distribute resource requests over various resources available in the on-demand database service environment. The NFS 296 also can communicate with the QFS 292 to update the information stored on the NFS 296 or to provide information to the QFS 292 for use by servers located within the pod 244.

In some implementations, the pod includes one or more database instances 290. The database instance 290 can transmit information to the QFS 292. When information is transmitted to the QFS, it can be available for use by servers within the pod 244 without using an additional database call. In some implementations, database information is transmitted to the indexer 294. Indexer 294 can provide an index of information available in the database 290 or QFS 292. The index information can be provided to file servers 286 or the QFS 292.

Some of the disclosed methods, processes, devices, systems and computer-readable storage media described herein can be configured or designed for use in a multitenant database environment, such as described above with respect to system 16. In an example implementation, each organization or a group within the organization can be a respective tenant of the system.

In some implementations, each user of the database system 16 is associated with a “user profile.” A user profile refers generally to a collection of data about a given user. The data can include general information, such as a name, a title, a phone number, a photo, a biographical summary, a work history, or a status (for example, text describing what the user is currently doing, thinking or expressing). As described below, the data can include messages created by other users. In implementations in which there are multiple tenants, a user is typically associated with a particular tenant (or “organization”). For example, a user could be a salesperson of an organization that is a tenant of the database system 16.

A “record” generally refers to a data entity, such as an instance of a data object created by a user or group of users of the database system 16. Such records can include, for example, data objects representing and maintaining data for accounts, profiles, employment history, cases, opportunities, leads, files, documents, orders, pricebooks, products, solutions, reports and forecasts, among other possibilities. For example, a record can be for a business partner or potential business partner (for example, a client, vendor, distributor, etc.) of a user or a user's organization, and can include information describing an entire enterprise, subsidiaries of an enterprise, or contacts at the enterprise. As another example, a record can be a project that a user or group of users is/are working on, such as an opportunity (for example, a possible sale) with an existing partner, or a project that the user is trying to obtain. As a further example, a record can be a user profile with the employment history of the user or a document or file storing employment history information. A record has data fields that are defined by the structure of the object (for example, fields of certain data types and purposes). A record also can have custom fields defined by a user or organization. A field can include (or include a link to) another record, thereby providing a parent-child relationship between the records. In other implementations, for instance, when the record is stored and maintained in an unstructured database or data system, there may be no parent-child nor child-parent relationships between or among records and thus no hierarchical structure to the database.

In some implementations, data is stored in database system 16, including tenant database 22, in the form of “entity objects” (also referred to herein simply as “entities”). In some implementations, entities are categorized into “Records objects” and “Collaboration objects.” Each record can be considered a sub-object of the overarching Records object. In some implementations, Collaboration objects include, for example, a “Users object,” a “Groups object,” a “Group-User relationship object,” and a “Record-User relationship object”.

In some implementations, the Users object is a data structure that can be represented or conceptualized as a “Users Table” that associates users to information about or pertaining to the respective users including, for example, metadata about the users. In some implementations, the Users Table includes all of the users within an organization. In some other implementations, there can be a Users Table for each division, department, team or other sub-organization within an organization. In implementations in which the organization is a tenant of a multitenant enterprise platform, the Users Table can include all of the users within all of the organizations that are tenants of the multitenant platform. In some implementations, each user can be identified by a user identifier (“UserID”) that is unique at least within the user's respective organization. In some such implementations, each organization also has a unique organization identifier (“OrgID”).

In some implementations, the Groups object is a data structure that can be represented or conceptualized as a “Groups Table” that associates groups to information about or pertaining to the respective groups including, for example, metadata about the groups. In some implementations, the Groups Table includes all of the groups within the organization. In some other implementations, there can be a Groups Table for each division, department, team or other sub-organization within an organization. In implementations in which the organization is a tenant of a multitenant platform, the Groups Table can include all of the groups within all of the organizations that are tenants of the multitenant platform. In some implementations, each group can be identified by a group identifier (“GroupID”) that is unique at least within the respective organization.

In some implementations, the database system 16 includes a “Group-User relationship object.” The Group-User relationship object is a data structure that can be represented or conceptualized as a “Group-User Table” that associates groups to users subscribed to the respective groups. In some implementations, the Group-User Table includes all of the groups within the organization. In some other implementations, there can be a Group-User Table for each division, department, team or other sub-organization within an organization. In implementations in which the organization is a tenant of a multitenant platform, the Group-User Table can include all of the groups within all of the organizations that are tenants of the multitenant platform.

In some implementations, the Records object is a data structure that can be represented or conceptualized as a “Records Table” that associates records to information about or pertaining to the respective records including, for example, metadata about the records. In some implementations, the Records Table includes all of the records within the organization. In some other implementations, there can be a Records Table for each division, department, team or other sub-organization within an organization. In implementations in which the organization is a tenant of a multitenant platform, the Records Table can include all of the records within all of the organizations that are tenants of the multitenant platform. In some implementations, each record can be identified by a record identifier (“RecordID”) that is unique at least within the respective organization.

In some implementations, the database system 16 includes a “Record-User relationship object.” The Record-User relationship object is a data structure that can be represented or conceptualized as a “Record-User Table” that associates records to users subscribed to the respective records. In some implementations, the Record-User Table includes all of the records within the organization. In some other implementations, there can be a Record-User Table for each division, department, team or other sub-organization within an organization. In implementations in which the organization is a tenant of a multitenant platform, the Record-User Table can include all of the records within all of the organizations that are tenants of the multitenant platform.

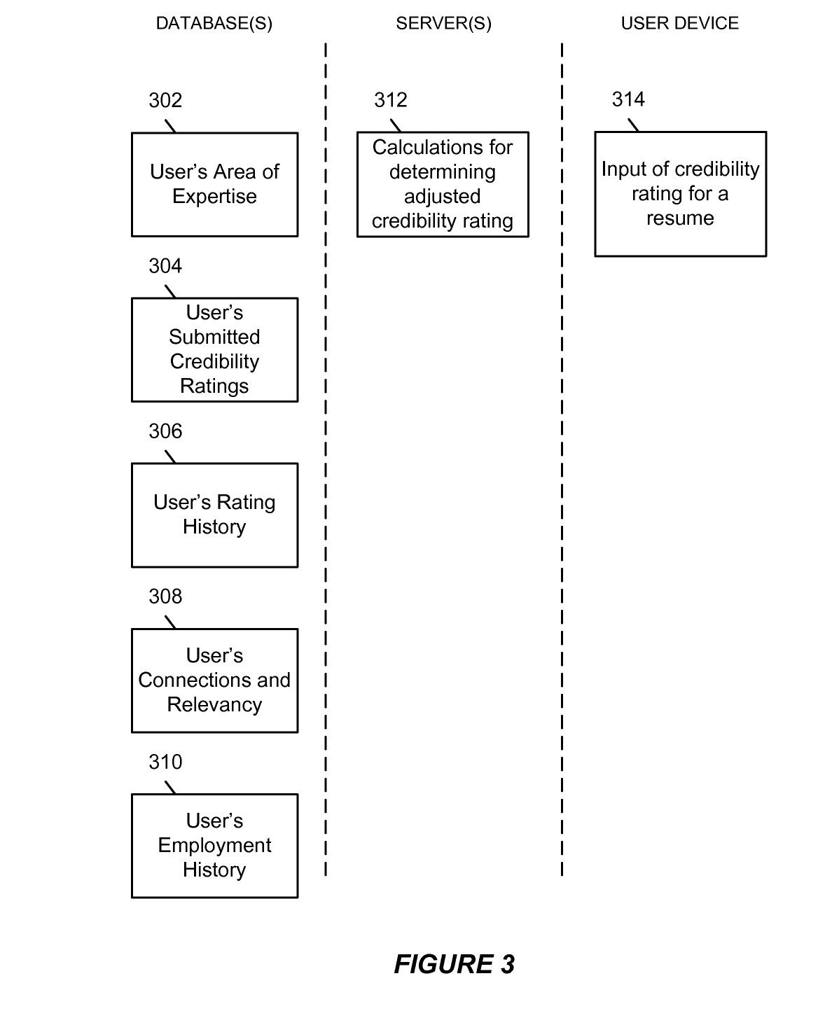

FIG. 3 shows a diagram illustrating an example of where data is stored and/or generated among a user device, one or more servers, and a database, in accordance with some implementations. The diagram of FIG. 3 is divided into three columns. In general, in this example, blocks located in the left column identify data stored in and operations performed using one or more databases of a database system. Blocks located in the center column identify data stored in and operations performed using a server of a database system. Blocks located in the right column identify data stored in and operations performed using a user device.

In the example of FIG. 3, the database stores one or more records identifying a rating user's area of expertise in block 302, credibility ratings submitted by the rating user in block 304, the rating user's rating history in block 306, information characterizing the rating user's connections and the relevancy of the connections in block 308, and the rating user's employment history in block 310. One or more of these data items may serve as a factor in calculating a credibility indicator or multiple credibility indicators for the rating user. For example, the rating user's area of expertise may be compared with the expertise area of a resume rated by the rating user. If the rating user's area of expertise is different, the credibility indicator may be adjusted to reflect that the rating user's rating may be less reliable than otherwise. This is illustrated in the case of Nancy, who has areas of expertise in marketing, sales, and business development. Nancy is rating a section of a resume belonging to Patrick describing Patrick's experience as a visual effects artist. Software associated with the social networking system can detect that Nancy does not have any relevant experience as a visual effects artist. Accordingly, the credibility indicator associated with Nancy's rating of the portion of Patrick's online resume concerning his experience as a visual effects artist may be lowered to reflect that visual effects is not an area of expertise for Nancy. Other examples and illustrations of how data stored in the database can be used to calculate the credibility indicator of a rating user or otherwise determine or adjust a credibility rating are disclosed herein.

Block 314 shows that the credibility rating may be entered by the rating user via a user device. The entered credibility rating may be communicated to the server and/or databases of the social networking system.

Block 312 shows that calculations for adjusting or otherwise determining a credibility rating may be performed by a server. For instance, a credibility rating entered by a rating user at block 314 may be adjusted. In some other implementations, adjustments to a credibility rating may be performed by any computing device of a network. The credibility rating may be determined using one or more algorithms. In such implementations, one or more of multiple algorithms is/are selected depending on what the rating user is rating. For example, if the rating user is rating the credibility of an entire resume of a posting user, a first algorithm may be selected, while if the rating user is rating only a component of the resume, such as the description of a projected that the posting user worked on, a different second algorithm, which may better reflect the technical field of the project, may be selected. Code for implementing algorithms may be stored within a database system or used via an online service external to the database system. The algorithm may use some or all of the information stored in the database that relates to the posting user, the rating user, and/or the online resume posted by the posting user.

In some implementations, a credibility rating is adjusted using a credibility indicator attached to the rating user, which can be applied to calculate or generate a score. As an illustrative example, Gina is a rating user rating the credibility of a project described by Kevin, the posting user, in Kevin's resume. A credibility indicator is retrieved or generated for Gina to assess Gina's credibility in rating Kevin's resume. In this example, the credibility indicator is calculated based on several factors: the rating user's area of expertise, the rating user's relationship with the posting user, and the credibility ratings calculated for the rating user's own resume(s). Thus, Gina's credibility indicator is calculated by taking into account that Gina works in the same field as Kevin, which is management consulting, that Gina was previously a co-worker with Kevin but was not a co-worker of Kevin's for the job that she is rating, and that Gina has relatively high credibility ratings for the resumes she has posted. In some implementations, the credibility indicator is calculated for each rating that Gina submits. In some other implementations, the credibility indicator is calculated once per rating user, is periodically updated, or is updated in response to changes in the rating user's profile, changes in the rating user's online resume, changes in the credibility ratings given to the rating user's resume components, etc. In some implementations, after the rating user's credibility indicator is calculated, the credibility rating entered by the rating user to rate the credibility of the posting user's resume component may be adjusted by applying the credibility indicator to arrive at an adjusted credibility rating. The adjusted credibility rating rather than the original credibility rating may then be used to indicate the truthfulness of the resume component.

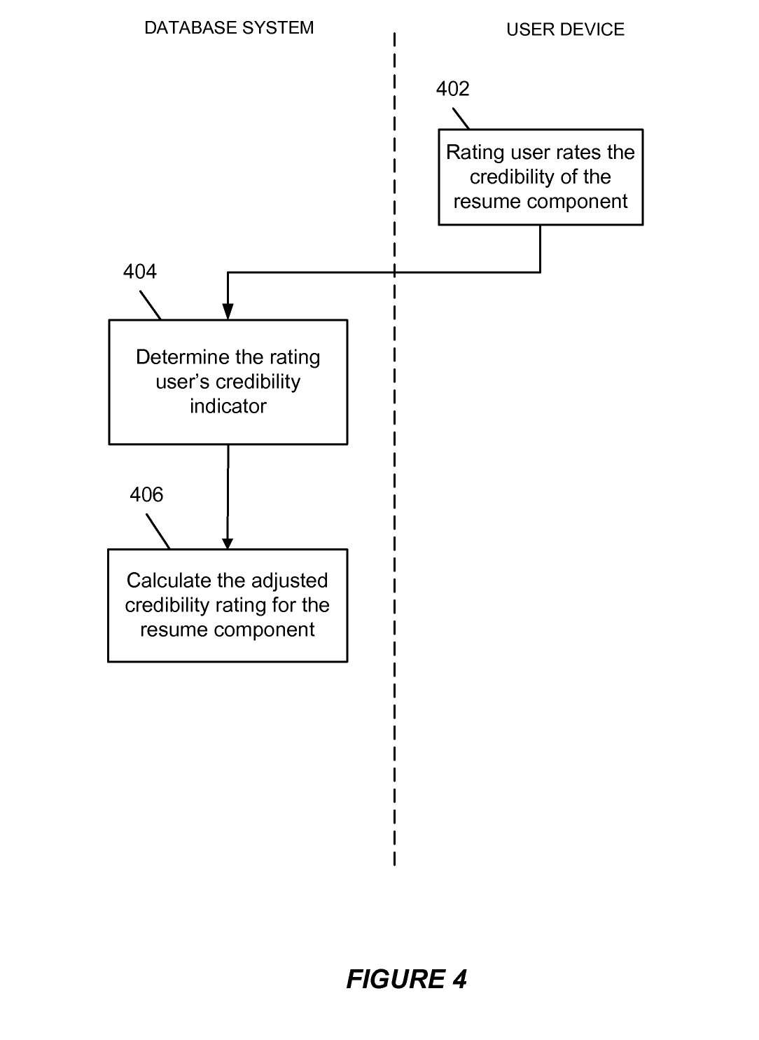

FIG. 4 shows a diagram illustrating an example of operations performed between a user device and a database system for using credibility ratings of users to process online resumes in a social networking environment, performed in accordance with some implementations. FIG. 4 is divided into two columns. On the left side is a column for blocks representing data stored at or operations performed at a database system using, for instance, a database, a server, multiple databases, multiple servers, or a combination of databases and servers. On the right side is a column containing blocks representing data stored at or operations performed at a user device.

In block 402, a rating user rates the credibility of a resume component of an online resume. The entered credibility rating may be inputted as a numerical value, such as a value between 1 and 10, a star rating such as 1, 2, 3, 4 or 5 stars, textual ratings in a progression such as “not credible,” “somewhat credible,” or “very credible”, by way of example. The entered credibility rating may then be communicated from the user device to a server or database associated with the social networking system that includes the online resume.

After the entered credibility rating has been communicated from the user device to the database system, the credibility indicator of the rating user may then be retrieved, calculated or adjusted in block 404. For example, the credibility indicator of the rating user may be stored as a data object linked with the rating user's user profile or user account in the system. In some implementations, the credibility indicator is manually set, while in some implementations, the credibility indicator is calculated using an original credibility rating entered by the rating user. In some implementations, the social networking system may assign a default credibility indicator to the rating user, or may calculate a credibility indicator based on various information in the profile of the rating user. Additionally, the default credibility indicator or the techniques used to calculate credibility indicators of users may change according to the number of users who are registered to the social networking system, or may change according to the number of users of the social networking system who have a calculated credibility indicator.

In block 406, the credibility rating entered at block 402 is adjusted. Some implementations may adjust the entered credibility rating using factors such as the credibility indicator of the rating user. Other factors may include the number of credibility ratings entered for the given resume component, characteristics of the resume component being rated, etc. By way of illustration, Rob has detailed two jobs on his posted resume: his jobs with Lemon, Inc. and with Bobble LLC. Rob listed his term of employment with Lemon, Inc. as from January 2012 to March 2013 and his term of employment with Bobble LLC as from January 2013 to present. Both his employment with Lemon, Inc. and with Bobble LLC are listed as full time positions. Because Rob's terms of employment with Lemon, Inc. and Bobble LLC overlap and both are full time positions, the inconsistency may be used as a factor to effectively lower the adjusted credibility rating.

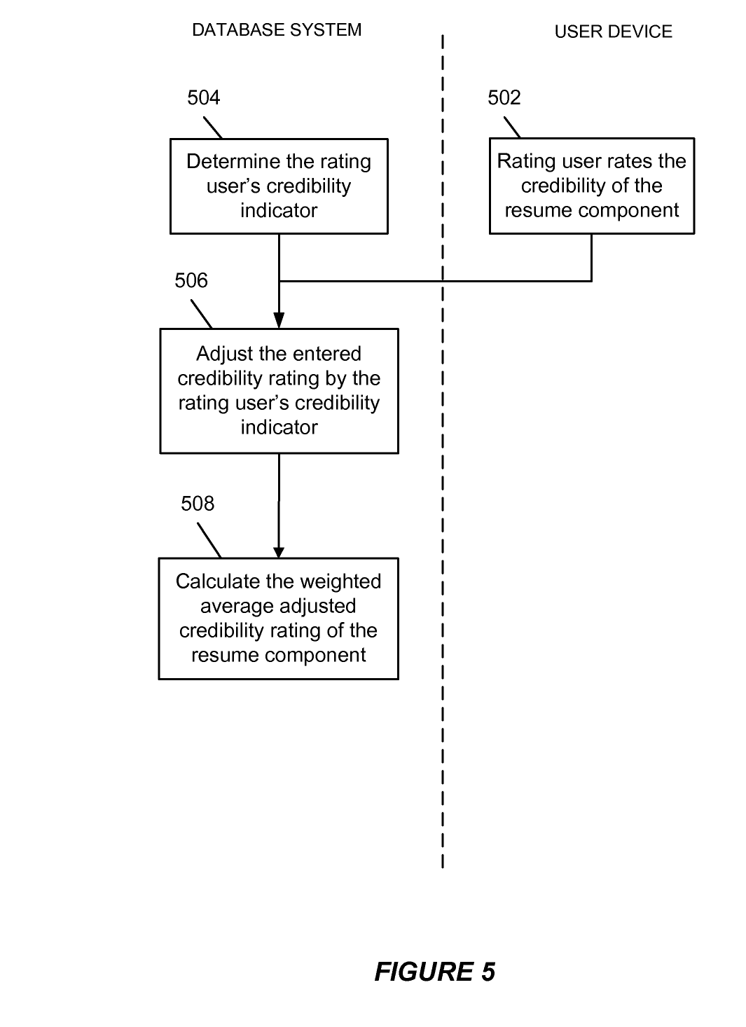

FIG. 5 shows a diagram illustrating an example of operations performed between a user device and a database system for using credibility ratings of users to process online resumes in a social networking environment, performed in accordance with some implementations.

In block 502, the rating user rates the credibility of a resume component through an entered credibility rating, as described above with reference to block 402. In block 504, after the credibility rating is transmitted from the user device to the database system, a server retrieves, calculates, and/or updates a credibility indicator of the rating user. For example, the credibility indicator may be have been previously applied for the user and stored in a database. In some implementations, the credibility indicator may be calculated or updated depending on factors such as credibility ratings from other users regarding the rating user, the duration that the rating user has been a member of the social networking system, the number of contacts that the rating user has, relationships of various contacts with the user, credibility ratings given by the rating user, patterns in the credibility ratings given by the rating user, the geographical location of the rating user, the employment history of the rating user, an area of expertise of the rating user, an employment history of the rating user, comments from other members of the social networking system, etc.

Accordingly, the credibility indicator of a rating user may, in some implementations, be raised if other users have rated the credibility of the rating user or the rating user's resume components as high, and vice versa. In some implementations, the credibility indicator may be lowered if the rating user does not have a threshold number of contacts or may be adjusted depending on the total number of contacts of the rating user. The credibility indicator may also possibly be lowered if the rating user has been a user of the social networking system for a relatively short duration of time. When the credibility indicator is adjusted according to the credibility ratings awarded by the rating user, in some implementations, a rating user who gives only the highest, lowest, or one score for all of his credibility ratings may have his credibility indicator lowered, since the pattern of behavior indicates that the rating user is not realistic in his ratings. On the other hand, a user who gives a diverse range of credibility ratings may have his credibility indicator raised. In another example, a rating user who gives consistently higher scores for a certain category of contacts, while giving consistently lower scores for another category, may have his credibility indicator lowered as a result. Other users of the social networking system may also rate the reliability of credibility ratings given by the rating user, and that may be reflected in the rating user's credibility indicator. In addition, a rating user who has contacts which are mostly or all former or current co-workers of the rating user may have a higher credibility indicator, as that reflects the rating user's contacts are only people whom the rating user has met. Also, a rating user who has a high degree of work experience in the area he is rating may also have a higher credibility indicator due to the greater experience. Finally, the employment history of the rating user may affect the credibility indicator, as users who frequently change jobs may be designated as having a low credibility.

In FIG. 5, in block 506, the entered credibility rating from block 502 is modified by the credibility indicator to arrive at an adjusted credibility rating. In the example of FIG. 5, the credibility indicator is maintained for the rating user in the database. The credibility indicator may modify the credibility rating in a variety of ways. For example, if the credibility rating is a numerical value, the credibility indicator may be a negative or positive value which is added to or subtracted from the credibility rating. Additionally, the credibility indicator may be used to multiply or divide the credibility rating, or the credibility indicator may be used to multiply or divide a value applied to the credibility rating through a mathematical operation. In some implementations, instead of calculating a credibility indicator, factors used to calculate the credibility indicator may be directly applied to the credibility rating. Thus, factors such as the rating user's area of expertise, employment history, and number of contacts may be used to directly modify the credibility rating.

In the example of FIG. 5, after the credibility rating has been adjusted in block 506, the adjusted credibility rating can be further modified in block 508 to arrive at a weighted average adjusted credibility rating. In block 508, the weighted average adjusted credibility rating is calculated by taking into account the credibility ratings submitted by some or all of the rating users who have submitted credibility ratings for the resume component. The credibility ratings submitted by other rating users may also have been adjusted by, for example, the credibility indicators associated with those other rating users. The adjusted credibility ratings of each user may then be used as factors to arrive at a weighted average adjusted credibility rating. In some implementations, the various adjusted credibility ratings submitted by the rating users may be averaged to arrive at the weighted average adjusted credibility ratings. In other implementations, the weights of the various adjusted credibility ratings used in determining the weighted average adjusted credibility ratings may be varied by considering factors such as the credibility indicator of each rating user associated with an adjusted credibility rating.

As an example, a resume component has been rated by Larry, Curly, and Moe. The credibility indicator for each rating user is measured on a scale of 1 to 5, with 5 being the most credible/reliable. A rating user enters a credibility rating on a scale of 1 to 10 for a resume component, with 10 being the most credible/reliable. In this example, credibility ratings from users who have a credibility indicator of 2 or lower are given no weight in calculating the weighted average adjusted credibility rating. Larry's credibility indicator has a value of 5. Curly's credibility indicator has a value of 4, while Moe's credibility indicator has a value of 1. Larry has given the resume component a credibility rating of 5, Moe has given the resume component a credibility rating of 10, and Curly has given the resume component a credibility rating of 7. Since Moe's credibility indicator is below the threshold, his credibility rating is given no weight. Thus, the weighted average adjusted credibility rating is calculated with just Larry and Curly's credibility ratings. In this example, the weighted average adjusted credibility rating is calculated through the formula: (CI_{A}*CR_{A}+CI_{B}*CR_{B} . . . CI_{N}*CR_{N})/(CI_{A}+CI_{B} . . . CI_{N}), where CI is the numerical value of the credibility indicator of a given rating user A, B, . . . N and CR is the numerical value of the credibility rating entered by the rating user. Using this formula, the weighted average adjusted credibility rating of the resume component is determined to be (5*5+4*7)/(5+4)=5.9.

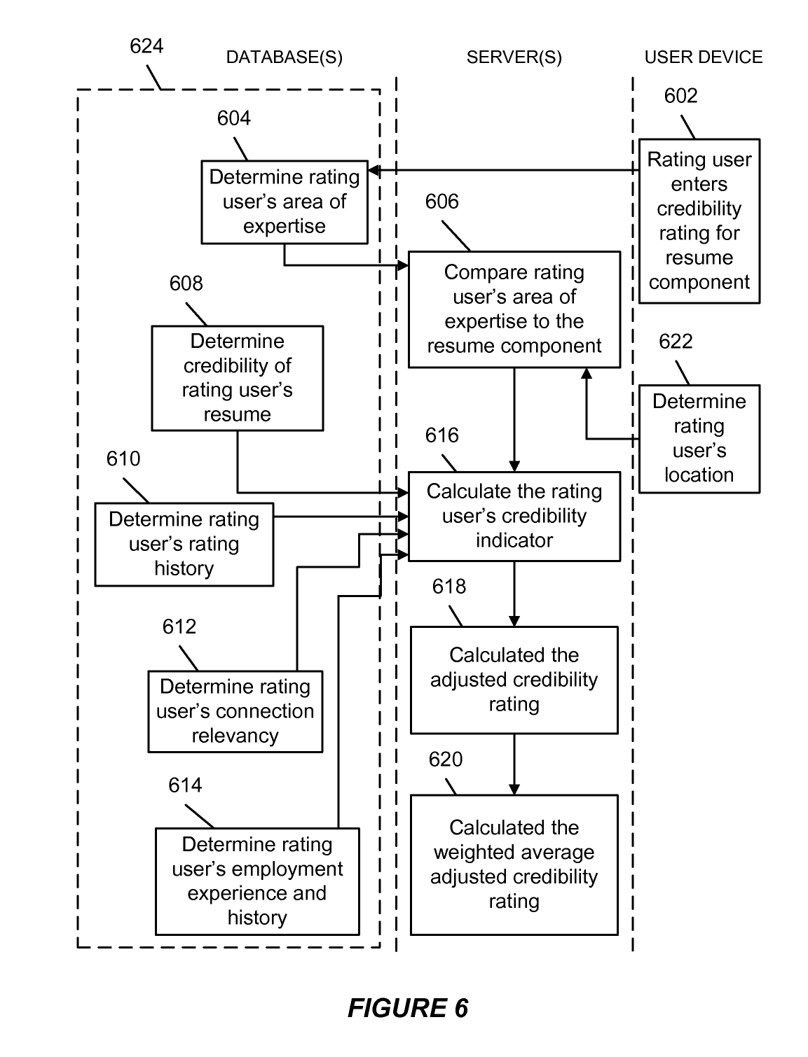

FIG. 6 shows a diagram illustrating an example of operations performed among a user device, one or more servers, and a database for using credibility ratings of users to process online resumes in a social networking environment, performed in accordance with some implementations.

In block 602, a rating user enters a credibility rating for a resume component posted on the social networking system. After the rating user enters the credibility rating in block 602, the data of the blocks in region 624 serve as factors to calculate an adjusted credibility rating or a weighted average adjusted credibility rating for the resume component. In block 604, the rating user's area of expertise is determined by, for example, analyzing a posted resume of the rating user, by endorsements given by contacts of the rating user, by surveys taken by the rating user, or by other methods. The area of expertise and the rating user's location, determined in block 622, may then be used as factors in comparing the rating user's area of expertise to the subject matter of the resume component in block 606. In some implementations, the rating user's location may be a factor in determining the level of expertise that the rating user possesses. For example, in determining the credibility indicator of computer scientists, a computer scientist residing in an area of the world renowned for their tech industry may be accorded a higher credibility indicator.

In block 608, the credibility of the rating user's resume components are determined, while the rating user's rating history is determined in block 610. In block 612, the rating user's number of connections or contacts and their relevancy and relationship to the rating user are determined, and in block 614, the rating user's employment experience and history is determined. The items determined in blocks 608-14, along with the comparison of the rating user's area of expertise to that of the subject matter of the resume component in block 606, are then used as factors in calculating the rating user's credibility indicator in block 616. After the rating user's credibility indicator has been determined, the adjusted credibility rating for the resume component is then determined in block 618. The adjusted credibility rating may then be used as a factor in calculating the weighted average adjusted credibility rating in block 620.

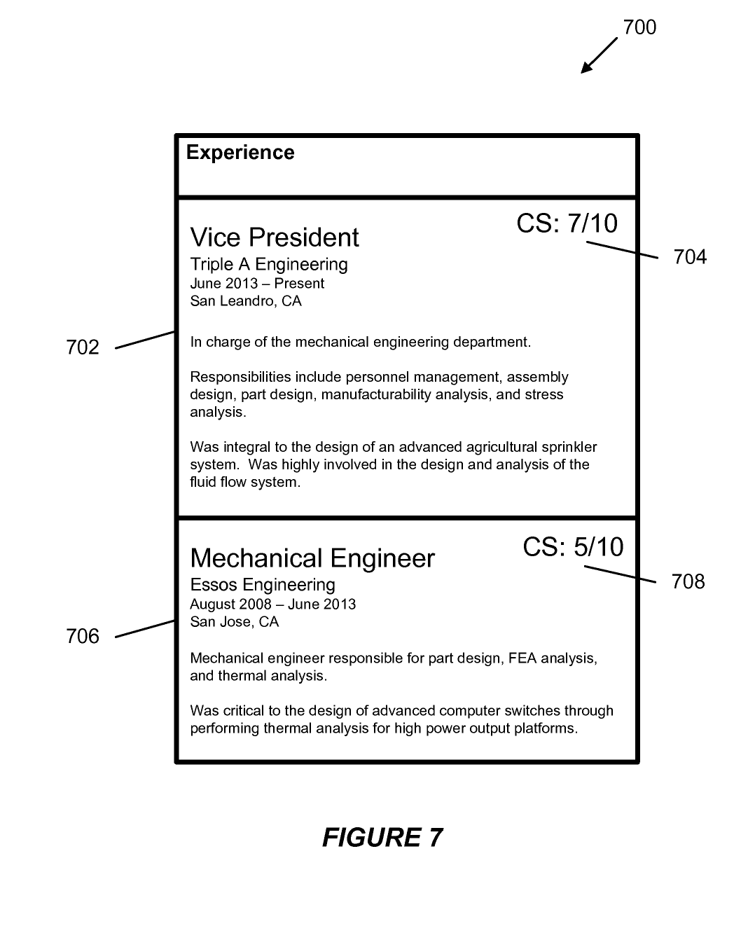

FIG. 7 shows an example of a presentation of an online resume in the form of a graphical user interface (GUI) as displayed on a computing device, in accordance with some implementations. In FIG. 7, the posting user has posted an online resume with two entries. One of the entries, entry 702, is directed to the posting user's role as vice president at Triple A Engineering. The other entry, entry 706, is directed to the posting user's role as a mechanical engineer with Essos Engineering. Both entry 702 and 706 have been rated by rating users, and each entry has a weighted average adjusted credibility rating. In the example of FIG. 7, the weighted average adjusted credibility rating is called a “credibility score” and is abbreviated as “CS” on the resume, which is part of a user profile of the posting user. The credibility score of each component, e.g. entry in this example, is on a scale of 1 to 10, with 10 being the most credible and 1 being the least credible. In FIG. 7, by applying some of the techniques disclosed herein, entry 702 has a credibility score 704 of 7 out of 10 displayed next to entry 702 while entry 706 has a credibility score 708 of 5 out of 10 displayed next to entry 706.

In some implementations, the credibility rating, adjusted credibility rating, and/or weighted average adjusted credibility rating of a resume component may be displayed near the resume component or may be displayed upon request. In some implementations, the ratings may be displayed when a user clicks on a link or embedded area of the resume component or online resume or when the user mouses over an area. If an implementation displays the credibility rating or adjusted credibility rating of a resume component, the identity of the associated rating user may also be displayed. In other implementations, the identity of the rating user is kept anonymous.

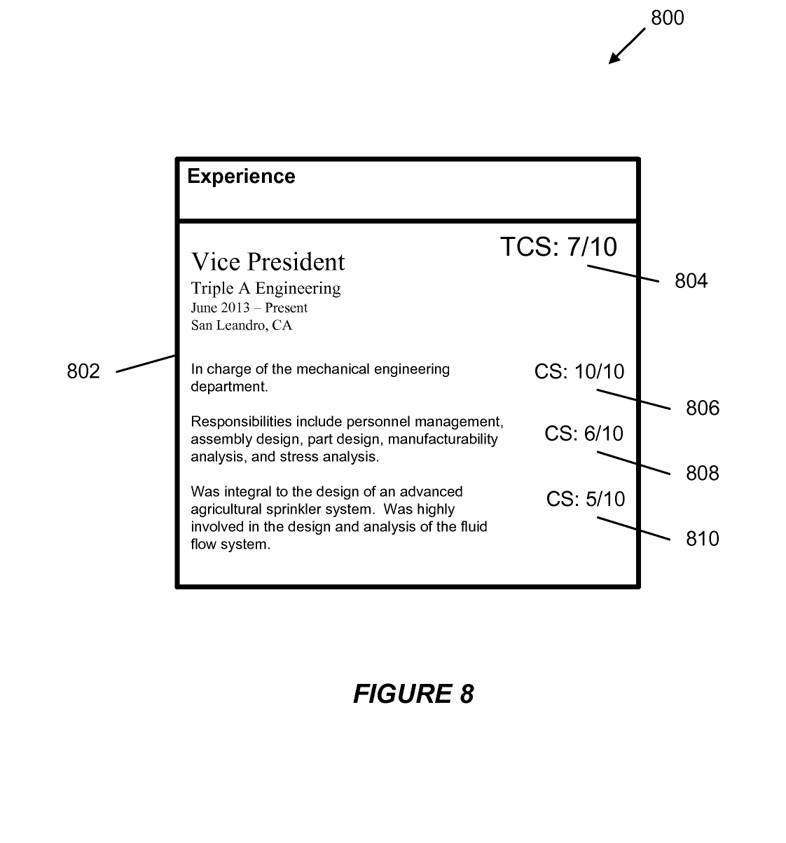

FIG. 8 shows an example of a presentation of another online resume in the form of a GUI as displayed on a computing device, in accordance with some implementations. FIG. 8 shows a modified view of entry 702 of FIG. 7 as an online resume. In this example, individual components of an entry can be rated. Thus, credibility ratings, adjusted credibility ratings, and/or weighted average adjusted credibility ratings are given to each component of resume 802. Accordingly, weighted average adjusted credibility rating 806 rates the credibility of the description that the posting user was in charge of the mechanical engineering department. Weighted average adjusted credibility rating 808 rates the credibility of the description of the posting user's responsibilities. Weighted average adjusted credibility rating 810 rates the credibility of the posting user's project descriptions. Additionally, there is a total credibility score 804 for the resume 802. The total credibility score 804, or the total weighted average adjusted credibility rating, may be calculated as a separate category with separate credibility ratings submitted by rating users, or may be calculated from the credibility ratings of the component parts. In the example of FIG. 8, the total credibility score is an average of the individual component weighted average adjusted credibility ratings.

The specific details of the specific aspects of implementations disclosed herein may be combined in any suitable manner without departing from the spirit and scope of the disclosed implementations. However, other implementations may be directed to specific implementations relating to each individual aspect, or specific combinations of these individual aspects.

While the disclosed examples are often described herein with reference to an implementation in which an on-demand database service environment is implemented in a system having an application server providing a front end for an on-demand database service capable of supporting multiple tenants, the present implementations are not limited to multitenant databases nor deployment on application servers. Implementations may be practiced using other database architectures, i.e., ORACLE®, DB2® by IBM and the like without departing from the scope of the implementations claimed.

It should be understood that some of the disclosed implementations can be embodied in the form of control logic using hardware and/or using computer software in a modular or integrated manner. Other ways and/or methods are possible using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions or commands on a computer-readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer-readable medium may be any combination of such storage or transmission devices. Computer-readable media encoded with the software/program code may be packaged with a compatible device or provided separately from other devices (e.g., via Internet download). Any such computer-readable medium may reside on or within a single computing device or an entire computer system, and may be among other computer-readable media within a system or network. A computer system, or other computing device, may include a screen, a monitor, printer, or other suitable display for providing any of the results mentioned herein to a user.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A database system comprising:
at least one database storing a plurality of online resumes as data objects; and
at least one server having at least one processor capable of executing instructions configured to cause:
processing data indicating a credibility rating submitted by a rating user of a social networking system implemented using the database system, the credibility rating submitted with regard to at least one component of an online resume of a posting user of the social networking system;
retrieving or generating a credibility indicator for the rating user, the credibility indicator indicating a credibility of the rating user;
adjusting the credibility rating according to the credibility indicator, the adjusted credibility rating indicating a trustworthiness of the at least one component of the online resume; and
storing one or more of the credibility indicator, the credibility rating, or the adjusted credibility rating as data in the database system.

2. The database system of claim 1, wherein adjusting the credibility rating according to the credibility indicator comprises:
applying the credibility indicator to a credibility value representing the credibility rating to produce a weighted credibility value.

3. The database system of claim 2, wherein applying the credibility indicator to the credibility value comprises one of:
weighting the credibility value according to the credibility indicator;
multiplying the credibility value by the credibility indicator; or
summing the credibility value with the credibility indicator.

4. The database system of claim 1, wherein the credibility indicator is based on at least one of a plurality of credibility factors comprising: a combined credibility rating for an online resume of the rating user, a history of credibility ratings submitted by the rating user, a number or percentage of connections of the rating user having historical relationships with the rating user, a work experience of the rating user, and a number or percentage of connections of the rating user identifiable as currently working at the same organization as the rating user and as having previously worked with the rating user at a different organization.

5. The database system of claim 4, wherein the history of credibility ratings submitted by the rating user comprises at least one of:
(i) credibility ratings submitted with regard to components of other online resumes associated with a subject area outside of a subject area of expertise of the rating user, or
(ii) an average of the credibility ratings submitted by the rating user.

6. The database system of claim 5, wherein the subject area outside of the subject area of expertise of the rating user has one degree of separation from the subject area of expertise of the rating user.

7. The database system of claim 4, wherein the connections comprise at least one of: a current co-worker, a previous co-worker, a current project member, a previous project member, a person having a current contractual relationship, a person having a previous contractual relationship, a person having a current professional relationship, and a person having a previous professional relationship.

8. A database system comprising:
at least one database storing a plurality of online resumes as data objects; and
at least one server having at least one processor capable of executing instructions configured to cause:
maintaining a plurality of credibility ratings submitted by a plurality of rating users of a social networking system implemented using the database system, the credibility ratings submitted with regard to an online resume of a posting user of the social networking system;
retrieving or generating a respective one of a plurality of credibility indicators for each of the rating users;
adjusting the credibility rating of each of the rating users according to the respective credibility indicator for the rating user, the adjusted credibility rating indicating a trustworthiness of the online resume; and
storing one or more of a credibility indicator, a credibility rating, or an adjusted credibility rating as data in the database system.

9. The database system of claim 8, wherein adjusting a credibility rating according to a respective credibility indicator comprises:
applying the respective credibility indicator to a credibility value representing the credibility rating to produce a respective weighted credibility value.

10. The database system of claim 8, the instructions further configured to cause:
combining the adjusted credibility ratings to produce a combined credibility rating.

11. The database system of claim 10, wherein combining the adjusted credibility ratings to produce the combined credibility rating comprises at least one of:
summing the adjusted credibility ratings;
determining a weighted value for each adjusted credibility rating, wherein the weighted value indicates an impact of the adjusted credibility rating on the combined credibility rating;
averaging the adjusted credibility ratings; or
determining a weighted average of the adjusted credibility ratings.

12. The database system of claim 10, the instructions further configured to cause:
determining that a number or percentage of rating users exceeding a threshold number or percentage have submitted credibility ratings.

13. A method implemented using a database system storing a plurality of online resumes as data objects, the method comprising:
receiving, at a server, a plurality of credibility ratings submitted by a plurality of rating users of a social networking system implemented using the database system, the credibility ratings submitted with regard to an online resume of a posting user of the social networking system;
retrieving or generating a respective one of a plurality of credibility indicators for each of the rating users;
adjusting the credibility rating of each of the rating users according to the respective credibility indicator for the rating user, the adjusted credibility rating indicating a trustworthiness of the online resume; and
storing one or more of a credibility indicator, a credibility rating, or an adjusted credibility rating as data in the database system.

14. The method of claim 13, further comprising combining the adjusted credibility ratings to produce a combined credibility rating, the combining comprising at least one of:
summing the adjusted credibility ratings;
determining a weighted value for each adjusted credibility rating, wherein the weighted value indicates an impact of the adjusted credibility rating on the combined credibility rating;
averaging the adjusted credibility ratings; or
determining a weighted average of the adjusted credibility ratings.

15. The method of claim 13, further comprising:
determining that a number or percentage of rating users exceeding a threshold number or percentage have submitted credibility ratings.

16. The method of claim 13, wherein a credibility indicator is based on at least one of a plurality of credibility factors comprising: a combined credibility rating for an online resume of the rating user, a history of credibility ratings submitted by the rating user, a number or percentage of connections of the rating user having historical relationships with the rating user, a work experience of the rating user, and a number or percentage of connections of the rating user identifiable as currently working at the same organization as the rating user and as having previously worked with the rating user at a different organization.

17. A system comprising:
database system software stored on a non-transitory data storage medium for execution by at least one server of a database system storing a plurality of online resumes as data objects, the database system software operable to cause:
maintaining a plurality of credibility ratings submitted by a plurality of rating users of a social networking system implemented using the database system, the credibility ratings submitted with regard to an online resume of a posting user of the social networking system,
retrieving or generating a respective one of a plurality of credibility indicators for each of the rating users,
adjusting the credibility rating of each of the rating users according to the respective credibility indicator for the rating user, the adjusted credibility rating indicating a trustworthiness of the online resume, and
storing one or more of a credibility indicator, a credibility rating, or an adjusted credibility rating as data in the database system.

18. The system of claim 17, the database system software further operable to cause combining the adjusted credibility ratings to produce a combined credibility rating, wherein combining the adjusted credibility ratings comprises at least one of:
summing the adjusted credibility ratings;
determining a weighted value for each adjusted credibility rating, wherein the weighted value indicates an impact of the adjusted credibility rating on the combined credibility rating;
averaging the adjusted credibility ratings; or
determining a weighted average of the adjusted credibility ratings.

19. A computer program product comprising program code to be executed by at least one processor when retrieved from a non-transitory computer-readable medium, the program code comprising instructions configured to cause:
maintaining, by a server, a plurality of credibility ratings submitted by a plurality of rating users of a social networking system implemented using a database system storing a plurality of online resumes as data objects, the credibility ratings submitted with regard to an online resume of a posting user of the social networking system;
retrieving or generating a respective one of a plurality of credibility indicators for each of the rating users;
adjusting the credibility rating of each of the rating users according to the respective credibility indicator for the rating user, the adjusted credibility rating indicating a trustworthiness of the online resume; and
storing one or more of a credibility indicator, a credibility rating, or an adjusted credibility rating as data in the database system.

20. The computer program product of claim 19, wherein a credibility indicator is based on at least one of a plurality of credibility factors comprising: a combined credibility rating for an online resume of the rating user, a history of credibility ratings submitted by the rating user, a number or percentage of connections of the rating user having historical relationships with the rating user, a work experience of the rating user, and a number or percentage of connections of the rating user identifiable as currently working at the same organization as the rating user and as having previously worked with the rating user at a different organization.
